(19) United States
(12) Patent Application Publication
(10) Pub. No.: US 2022/0033718 A1
(43) Pub. Date: Feb. 3, 2022

(54) AROMATIC RECOVERY COMPLEX WITH A HYDRODEARYLATION STEP TO PROCESS CLAY TOWER EFFLUENTS

(71) Applicant: Saudi Arabian Oil Company, Dhahran (SA)

(72) Inventors: Omer Refa Koseoglu, Dhahran (SA); Robert Peter Hodgkins, Dhahran (SA)

(73) Assignee: Saudi Arabian Oil Company, Dhahran (SA)

(21) Appl. No.: 16/944,394

(22) Filed: Jul. 31, 2020

(51) Int. Cl. C10G 47/02

(52) U.S. Cl. CPC C10G 47/02; C10G 2300/4018; C10G 2300/4012; C10G 2300/1096; C10G 2400/30; C10G 2300/308; C10G 2300/4006

(57) ABSTRACT

The disclosure provides a process to hydrodearylate the non-condensed alkyl-bridged multi-aromatics at the outlet of the clay tower where such multi-aromatics form rather than performing hydrodearylation on the reject stream of the aromatics complex. Hydrodearylation may feature combining a C₈₊ hydrocarbon stream from a clay treater with a hydrogen stream over a catalyst bed comprising a support and an acidic component optionally containing Group 8 and/or Group 6 metals.

### TECHNICAL FIELD

The present disclosure generally relates to processes for hydrodearylation of the non-condensed alkyl-bridged multi-aromatics from a C₈₊ stream within an aromatic production complex.

### BACKGROUND

A typical refinery starts with a crude oil feed into an atmospheric distiller to roughly separate the components therein by their condensation/evaporation temperatures, where they are fed into further processing units, which in turn can feed in to further processing units, until high purity compounds or classes of compounds are obtained. For example, from an atmospheric distiller, a naphtha stream can run off to a hydrotreater (NHT) and naphtha reforming unit (NREF) to remove sulfur-based contaminants with the resulting reformate split into a gasoline pool and an aromatics recovery complex (ARC).

### SUMMARY

Within the ARC, various further processes can be applied to convert naphtha or pyrolysis gasoline into benzene, toluene, and mixed xylenes (BTX), which are basic petrochemical intermediates used for the production of various other chemical products. To maximize the BTX production, the feed to an ARC is generally limited from C₆ up to C₁₁ compounds. In most ARCs, the aromatics present in reformate are usually separated into different fractions by carbon number; such as benzene, toluene, xylenes, and ethylbenzene, etc. The C₈ fraction may then be subjected to a further processing scheme to generate more high value para-xylene. Para-xylene is usually recovered in high purity from the C₈ fraction by separating the para-xylene from the ortho-xylene, meta-xylene, and ethylbenzene using selective adsorption or crystallization. The remaining ortho-xylene and meta-xylene are isomerized in a further unit to produce an equilibrium mixture of xylenes and recycled back to extract para-xylene. Ethylbenzene is isomerized into xylenes or is dealkylated to benzene and ethane. The para-xylene-depleted-stream is then recycled to extinction through the isomerization unit and then to the para-xylene recovery unit until all of the ortho-xylene and meta-xylene are converted to para-xylene and recovered. The para-xylene can then be processed to produce terephthalic acid, which is then used to make polyesters, such as polyethylene terephthalate.

To increase the production of benzene and para-xylene, toluene and C₉ and C₁₀ aromatics are processed within the complex through a toluene, C₉, C₁₀ transalkylation/toluene disproportionation (TA/TDP) process unit to produce benzene and xylenes. Any remaining toluene, C₉, and C₁₀ aromatics are recycled to extinction. Compounds heavier than C₁₀ are generally not processed in the TA/TDP unit, as they tend to cause rapid deactivation of the catalysts used at the higher temperatures used in these units, often greater than 400° C.

Before para-xylene is recovered from the mixed xylenes, the C₈₊ feed to the selective adsorption unit is processed to eliminate olefins and alkenyl aromatics such as styrene in the feed. Olefinic material can react and occlude the pores of the zeolite adsorbent. The olefinic material is removed by passing a C₈₊ stream across a clay or acidic catalyst to react olefins and alkenyl aromatics with another (typically aromatic) molecule, forming heavier compounds (C₁₆₊). These heavier compounds are typically removed from the mixed xylenes by fractionation. The heavy compounds are generally removed from the complex as lower value fuels blend stock.

Also during hydrocarbon processing, compounds composed of an aromatic ring with one or more coupled alkyl groups containing three or more carbon molecules per alkyl group may be formed. Formation of these compounds may be from processes used by petroleum refiners and petrochemical producers to produce aromatic compounds from non-aromatic hydrocarbons, such as catalytic reforming. As many of these heavy alkyl aromatic compounds fractionate with the fractions containing greater than 10 carbon atoms, they are not typically sent as feedstock to the transalkylation unit, and instead are sent to gasoline blending or used as fuel oil.

Accordingly, ongoing needs exist for improved methods and systems for producing light aromatics within a refinery system. Disclosed herein are processes to generate light alkyl mono-aromatic compounds from the heavy alkyl aromatic and alkyl-bridged non-condensed alkyl aromatic compounds instead of using such for low-value fuel oil blending or gasoline blending at the expense of the gasoline quality. Due to the desire to produce valuable para-xylene, placement of a hydrodearylation unit within the aromatics recovery complex provides additional materials for the xylene re-run to maximize para-xylene production.

The present disclosure provides a process to recover or improve the presence of alkyl mono-aromatic compounds. In some instances, the process includes directing a feed stream from a clay treater of an aromatic recovery complex to a hydrodearylation unit. The feed stream includes C₈₊ compounds of one or more heavy alkyl aromatic compounds and alkyl-bridged multi-aromatic compounds. The hydrodearylation unit dearylates alkyl-bridged multi-aromatic compounds through adding a hydrogen stream to the feed stream over a catalyst, resulting in production of an alkyl mono-aromatic compound containing stream, which can then feed into a xylene re-run unit.

In some aspects, the alkyl-bridged alkyl multi-aromatic compounds in the feed stream include at least two benzene rings connected by an alkyl bridge group of at least two carbons, with the benzene rings being connected to different carbons of the alkyl bridge group.

In some aspects, the clay treater is operated at a temperature between 160° C. and 220° C. In further aspects, the clay treater is operated at a range of 1-20 bars. In certain aspects, the clay treater is operated at a liquid hourly space velocity (LHSV) of about 0.5 hr⁻¹ to about 10 hr⁻¹. In yet other aspects, the clay treater outlet effluent has a bromine index less than 200. In some aspects, the clay treater outlet effluent is substantially olefin free, such as less than 0.2 weight percent.

In some instances, the hydrogen stream is combined with the feed stream before being supplied to the hydrodearylation unit. In some aspects, the hydrogen stream may include of a recycled hydrogen stream and a makeup hydrogen stream.

In some instances, the catalyst is presented as a catalyst bed in the hydrodearylation unit. In certain aspects, a portion of the hydrogen stream is fed to the catalyst bed in the hydrodearylation unit to quench the catalyst bed. The catalyst may include a support of silica, alumina, or combinations thereof, and an acidic component of amorphous silica-alumina, zeolite, or combinations thereof. In some aspects, the catalyst may include an IUPAC Group 8-10 metal of iron, cobalt, and nickel, or combinations thereof and an IUPAC Group 6 metal of molybdenum, tungsten, or combinations thereof. In certain aspects, the IUPAC 8-10 metal may be 2 to 20 percent by weight of the catalyst and the IUPAC Group 6 metal may be 1 to 25 percent by weight of the catalyst. In certain aspects, the catalyst may include nickel, molybdenum, ultrastable Y-type zeolite, and γ-alumina support.

In some instances, the hydrodearylation unit includes an operating temperature within of about 200 to about 450° C. In certain aspects, the hydrodearylation unit may include a hydrogen partial pressure within of about 5 to about 50 bars. The hydrodearylation unit may include a feed rate of the hydrogen stream of about 100 to about 1000 standard liters per liter of feedstock.

In some instances, the aromatic recovery complex receives a reformate stream from a catalytic reforming unit. A reformate splitter within the aromatic recovery complex may then split the reformate stream into a C₅+C₆ stream that goes to a benzene extraction unit and a C₇₊ stream that feeds to a splitter. The splitter can then divide the C₇₊ stream into a C₇ stream and a C₈₊ stream that passes through the clay treater and thereafter into the hydrodearylation unit. Further, in some instances, the xylene re-run unit may split the alkyl mono-aromatic compound stream into a C₉₊ stream and a C₈ stream that flows to a para-xylene extraction unit and a xylene isomerization unit which can then recycle back to the xylene re-run unit.

Additional features and advantages of the described embodiments will be set forth in the detailed description, which follows, and in part will be readily apparent to those skilled in the art from that description or recognized by practicing the described embodiments, including the detailed description, which follows, the claims, as well as the appended drawing.

### BRIEF DESCRIPTION OF THE DRAWINGS

FIG. 1 shows an overview of a traditional refinery system of processes.

FIG. 2 shows a more detailed overview of the processes of an aromatics recovery complex (ARC).

FIG. 3 shows a hydrodearylation unit placed to receive an aromatic bottoms stream.

FIG. 4 shows a hydrodearylation unit according to the current disclosure that receives a C₈₊ stream from a clay treater feed prior to entry into a xylene re-run system.

The embodiments set forth in the drawing are illustrative in nature and not intended to be limiting to the claims. Moreover, individual features of the drawings will be more fully apparent and understood in view of the detailed description.

### DETAILED DESCRIPTION

This disclosure describes various processes and systems for feeding a C₈₊ stream in an aromatics recovery complex to a hydrodearylation unit for conversion of alkyl-bridged non-condensed alkyl aromatics to lighter mono-alkyl aromatics for improved para-xylene recovery in a refinery.

As used herein, the term “hydrodearylation” refers to a reaction or series of steps to cleave alkyl bridges of non-condensed alkyl-bridged multi-aromatics or heavy alkyl aromatic compounds to form alkyl mono-aromatics, in the presence a catalyst and hydrogen. “Alkyl bridged non-condensed alkyl aromatic” compounds refer at least two aromatic (or benzene) rings connected by an alkyl bridge group with at least two carbons bridging between the rings, where the aromatic or benzene rings are connected to different carbons of the alkyl bridge group.

As used herein, the term “stream” (and variations thereof) refers to a connected pathway flow of vapors, gases or liquids from one source or system or unit to a second. In many instances, a stream may feature one or more of various hydrocarbon compounds, such as straight chain, branched or cyclical alkanes, alkenes, alkadienes, alkynes, alkyl aromatics, alkenyl aromatics, condensed and non-condensed di-, tri- and tetra-aromatics, and gases such as hydrogen and methane, C₂₊ hydrocarbons and further may include various impurities.

Heavy aromatics are byproducts formed during various processing steps during refining of crude oil. Heavy aromatics include mono-aromatics with long attached alkyl groups, as well as multi-aromatics of two or more aromatic rings linked with alkyl bridges. U.S. Pat. No. 10,053,401, identified that aromatic bottoms of C₉₊ hydrocarbons can be subjected to hydrodearylation using a hydrogen stream and a catalyst to cleave or sever the alkyl bridges and recover lighter mono-aromatics. Recovered mono-aromatics can then be processed to increase the yield of BTX compounds from refineries.

The clay treater within an aromatics recovery complex is present to remove olefins prior to xylene purification and recycling. By way of example, the clay treater may be operated at a temperature between 160° C. and 220° C. and at a pressure range of 1-20 bars. In some instances, the connected unit is at an elevated height. The clay treater may be operated at a liquid hourly space velocity (LHSV) of between 0.5 hr⁻¹ and 10 hr⁻¹ and with an outlet effluent bromine index of 200 or less.

While the clay treater is effective for reducing olefin content, the acidity of the clay and the temperature of the clay treater provides an opportunity for alkenyl aromatics to react with alkyl aromatics to form non-condensed alkyl-bridged di-aromatics. Some di-aromatics can similarly react to form tri-aromatics and so on, providing a site for multi-aromatics production prior to being received at the xylene re-run column where mono-aromatic C₈ compounds (e.g. xylenes) are to be isolated. As C₈ compounds can be depleted during the clay treating, it is a function of this disclosure to recover light mono-aromatics prior to xylene purification to improve yields and reduce loss of valuable hydrocarbons. The recovery includes, therefore, not just alkyl aromatics that reacted with alkenyl aromatics, but the alkenyl aromatics now reduced to alkyl aromatics.

The disclosure therefore relates to introducing a hydrodearylation unit into an aromatics recovery complex within a refinery. In some instances, the hydrodearylation unit is introduced between a clay treater and a xylene re-run unit to increase the alkyl mon-aromatic compounds entering the xylene re-run unit. A hydrodearylation unit assists in the recovery of light alkylated mono-aromatics from streams that contain alkyl-bridged non-condensed alkylated multi-aromatic compounds and heavy alkyl-aromatic compounds. Alkyl-bridged non-condensed alkyl aromatic compounds may be referred to as multi-aromatics or poly-aromatics. A more in-depth description of the hydrodearylation process is found in U.S. Pat. No. 10,053,401, which is hereby incorporated by reference in its entirety.

Hydrodearylation refers to generating mono-aromatic or alkyl aromatic compounds from multi-aromatics, through a process of dearylation or cleaving of the alkyl bridge(s) between the aromatic rings. As set forth herein, a hydrodearylation unit receives a stream of C₈₊ hydrocarbon compounds that include multi- or poly-aromatic compounds. In some instances, the C₈₊ stream may be from a clay treater in an aromatics recovery complex. Clay treatment (or clay filtration; e.g. using a clay treater) refers to a process by which contaminants, such as olefins and alkenyl aromatics, may be removed in an aromatics recovery complex. Typically, a stream may be passed through or over a clay treater or clay tower, where it comes into contact with a surface of the clay. The olefinic species are composed primarily of alkenyl aromatics, such as styrene and methyl-styrene. Such molecules would be expected to react across clay-containing Lewis-acid sites at temperatures around 200° C. with the alkyl aromatics via a Friedel-Crafts reaction to form molecules with two aromatic rings connected with an alkyl bridge. Analysis of spent clay from a commercial unit found polar solvent (i.e., toluene and tetrahydrofuran) soluble hydrocarbons and solvent insoluble hydrogen deficient hydrocarbons on the clay surface. Solvent soluble hydrocarbons are leftovers from the reformate stream and solvent insoluble hydrogen deficient hydrocarbons are basically coke and removed at temperature 400° C. and above.

The C₈₊ stream from the day treater is contacted or combined with a further stream of hydrogen as an initial step in hydrodearylation. The two may be contacted wither before or following entry into the unit, but prior to collectively flowing over any catalyst therein.

The combined flow of the C₈₊ hydrocarbon stream and hydrogen may then contact a catalyst. Collectively, the combination of hydrogen and the catalyst allows for hydrodearylation to occur. The product stream leaves the unit containing newly generated mono-aromatic compounds. The processes for conversion of multi-aromatics into alkyl aromatics may allow for the use of the alkyl aromatics as feedstock to a benzene, toluene, and xylenes (BTX) petrochemicals processing unit.

In the hydrodearylation unit, the catalyst may be provided as an exposed bed in a reactor. In some instances, a portion of the hydrogen stream may be fed to the catalyst bed in the reactor to provide quenching to the catalyst bed. In some aspects, the catalyst bed may include two or more catalyst beds. The catalyst may further include a support, such as a support selected from silica, alumina, titania and/or combinations thereof. The catalyst may also include an acidic component(s) selected from amorphous silica-alumina, zeolite, and/or combinations thereof. The catalyst may include a Group 8-10 (per IUPAC grading) metal and/or a Group 6 (IUPAC) metal. The catalyst may be a metal selected from iron, cobalt, nickel, and/or combinations thereof. The catalyst may further include a metal selected from the group consisting of molybdenum, tungsten, and/or combinations thereof. The catalyst, in some instances, may contain an IUPAC Group 8-10 metal at about 2 to 20 percent by weight of the total weight of the catalyst (including 3, 4, 5, 6, 7, 8, 9, 10, 11, 12, 13, 14, 15, 16, 17, 18, and 19%) and an IUPAC Group 6 metal at about 1 to 25 percent by weight of the total weight of the catalyst (including 2, 3, 4, 5, 6, 7, 8, 9, 10, 11, 12, 13, 14, 15, 16, 17, 18, 19, 20, 21, 22, 23, and 24%). The catalyst may include one or more of nickel, molybdenum, ultrastable Y-type zeolite, and γ-alumina support.

The hydrodearylation unit can be operated at a temperature of about 250° C. to about 400° C. and at a pressure from about 5 bar to about 50 bar. In some instances, the hydrodearylation unit is operated at about 350° C. and at a pressure of 15 bar.

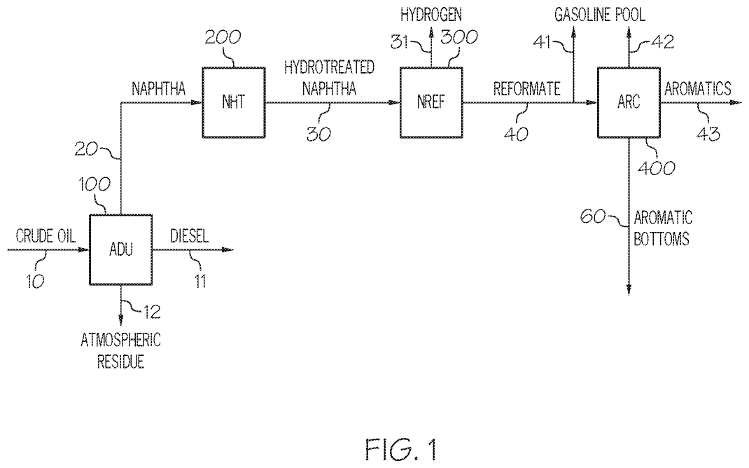

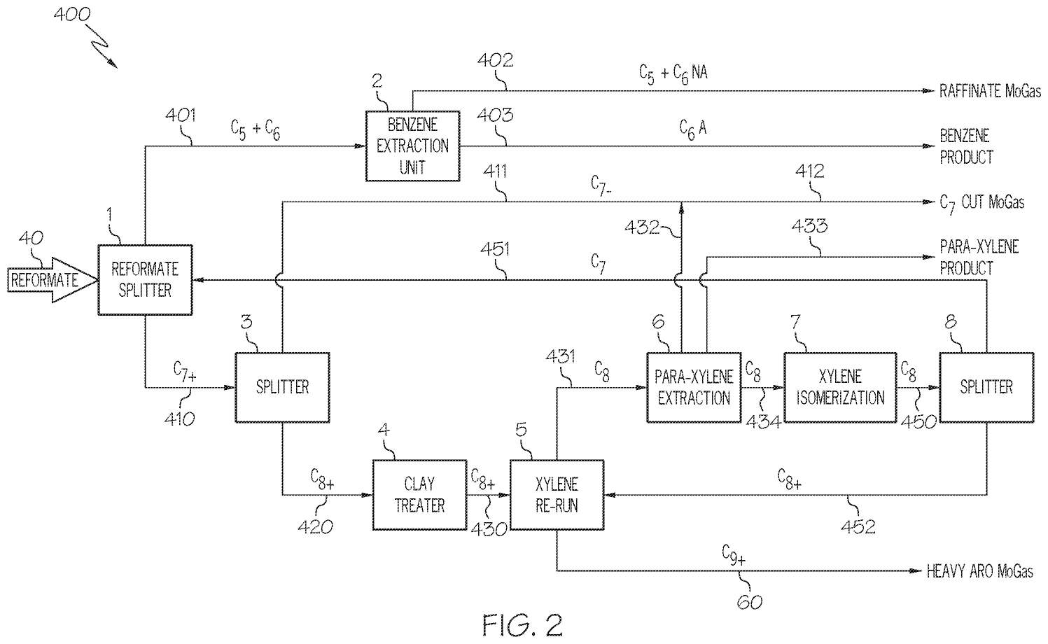

A typical refinery with an aromatic recovery complex (ARC) is presented in FIG. 1 and the details of the ARC are presented in FIG. 2. The whole crude oil is distilled in an atmospheric distillation unit (ADU) column to recover a naphtha fraction boiling in the range 36-180° C., a diesel fraction boiling in the range 180-370° C. and an atmospheric residue fraction boiling at 370° C. and higher. The naphtha fraction is hydrotreated in a naphtha hydrotreating unit (NHT) to remove sulfur and nitrogen content down to less than 0.5 ppmw (parts per million per weight) and the hydrotreated naphtha fraction is sent to catalytic reforming unit (NREF) to improve its quality, i.e., increase octane number to produce gasoline blending stream or feedstock for an aromatics recovery unit. Similarly, the diesel fraction is hydrotreated in a separate diesel hydrotreating unit (not shown) to desulfurize the diesel oil to obtain a diesel fraction meeting stringent specifications of <10 ppm sulfur. The atmospheric residue fraction is either used as a fuel oil component or sent to other separation/conversion units to convert low value hydrocarbons to various fuel oil products. The reformate fraction emerging from the NREF can be used as gasoline blending component or sent to an aromatic recovery complex (ARC) to recover high value aromatics, i.e., benzene, toluene and xylenes, commonly called BTX.

FIG. 2 shows a more detailed view of a typical aromatic recovery complex (ARC). The reformate that is produced from the NREF is initially processed through a splitter to separate the reformate into two fractions: light and heavy reformate. The light reformate is sent to a benzene extraction unit to extract the benzene and recover almost benzene free gasoline. The heavy reformate stream is sent to a splitter and then a para-xylene extraction unit to recover para-xylene. Prior to entering the xylene re-run splitter, the heavy reformate passes through a clay treater to remove olefins from the system, which improves the zeolite adsorbent cycle length involved in selective adsorption processes when recovering para-xylene. Other xylenes are recovered after para-xylene extraction and sent to a xylene isomerization unit to convert them to para-xylene. The converted fraction is recycled back to the para-xylene extraction unit for appropriate extraction. The heavy fraction from the xylene re-run splitter is recovered as process reject or aromatic bottoms. Aromatic bottoms relate to C₉₊ aromatics and may be a more complex mixture of compounds including di-aromatics.

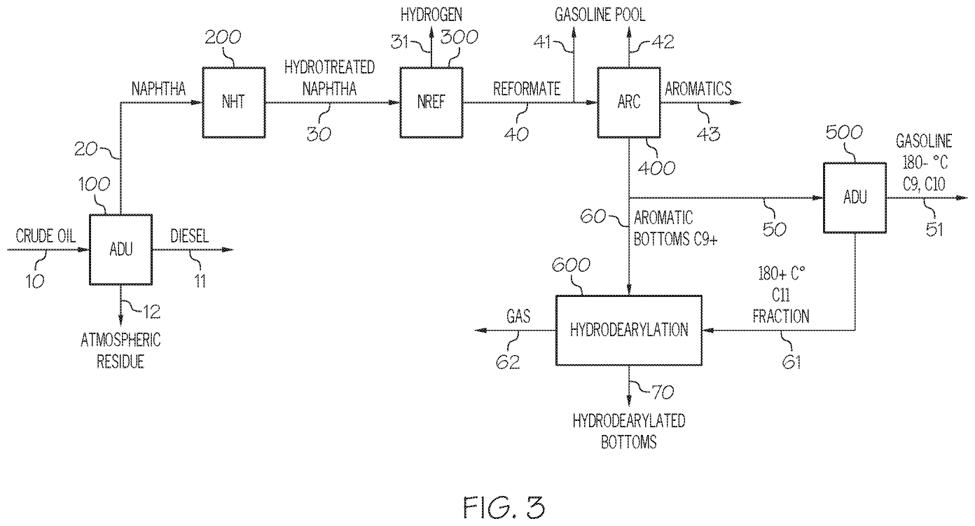

As outlined above, aromatic bottoms can be added to the gasoline pool or hydrodearylated per U.S. Pat. No. 10,053,401. The aromatics bottoms fraction from the xylene re-run splitter may then be either: i) fractionated with the 180−° C. fraction sent directly to a gasoline pool as blending components and the 180+° C. fraction sent to a hydrodearylation unit; or ii) fractionated such that the C₉ and C₁₀ components are sent directly to a transalkylation unit and the C₁₁₊ components are sent to a hydrodearylation unit or iii) sent directly to a hydrodearylation unit to recover light alkyl mono-aromatic compounds from heavy alkyl aromatic and alkyl-bridged non-condensed alkyl aromatic compounds (see, e.g. FIG. 3).

The present invention, conversely, concerns introducing a hydrodearylation within the ARC itself, particularly at the point of receiving a C₈₊ stream at the outlet of the clay treater. Alkyl-bridged non-condensed di-aromatics (or multi-aromatics) may form in the clay treater or tower as described herein. Typically, the effluent at the outlet of the clay treater is fractionated through the xylene re-run splitter and the resulting C₉₊ feed is sent as aromatic bottoms and potentially either hydrodearylated or the C₉ and C₁₀ components are removed and the C₁₁₊ stream can be hydrodearylated, since the heavy alkyl-bridged non-condensed di-aromatics (or multi-aromatics) are now in these heavier streams.

It is therefore a distinguishing facet of the present disclosure to introduce the hydrodearylation prior to fractionation at the xylene re-run splitter. Placement of a hydrodearylation unit at this point provides an opportunity to reduce multi-aromatics from being fractioned with C₉₊ hydrocarbons from the xylene re-run and increase the C₈ fraction for para-xylene extraction and isomerization. Hence, the embodiments of this disclosure offer an alternative process configuration for hydrodearylation by expanding hydrodearylation to process to the C₈₊ stream.

Referring now to FIG. 1, a schematic of a typical gasoline refinery system is shown. In the system, a crude oil inlet stream 10 is fed into an atmospheric distillation unit (ADU) 100, and therein crude oil is separated into a naphtha stream 20, an atmospheric residue stream 12, and a diesel stream 11. Crude oil is distilled in ADU 100 to recover naphtha, which boils in the range of about 36° C. to about 180° C., and diesel, which boils in the range of about 180° C. to about 370° C. The atmospheric residue fraction in the atmospheric residue stream 12 boils at about 370° C. and higher. The naphtha stream 20 then proceeds to a naphtha hydrotreating unit (NHT) 200. The naphtha stream 20 is hydrotreated in NHT 200 at between 200-260° C. and 25-45 bar to remove sulfur and nitrogen content to less than about 0.5 ppmw. A hydrotreated naphtha stream 30 exits the NHT 200 and enters a catalytic naphtha reforming unit (NREF) 300 to improve its quality by mixing with hydrogen at between 500 to 570° C. and 35 to 45 bar. A hydrogen stream 31 and a reformate stream 40 exit the NREF 300. A portion of the reformate stream 40 is separated by a pool stream 41 to a gasoline pool, with the remaining reformate stream 40 entering an aromatic complex (ARC) 400 to recover high value aromatics, such as benzene, toluene and xylenes. The ARC 400 separates the reformate into a pool stream 42 (e.g., C₄-C₁₀ non-aromatics), an aromatics stream (C₆-C₈ aromatics) 43, and an aromatic bottoms stream (C₉₊) 60.

Referring to FIG. 2, an overview of a typical ARC 400 is shown. The reformate stream 40 from the NREF 300 of FIG. 1 flows initially into a reformate splitter 1. to separate into a light C₅ and C₆ hydrocarbon reformate stream 401 and a heavy C₇₊ reformate stream 410. The C₅ and C₆ stream 401 feeds to a benzene extraction unit 2 to separate into C₅ and C₆ non-aromatic stream 402 for raffinate motor gasoline (MoGas) and a C₆ aromatics stream 403 for benzene products. The C₇₊ stream 410 feeds to a splitter 3 to produce a C₇ cut MoGas stream 411 and a C₈₊ hydrocarbon stream 420.

The C₈₊ stream 420 is run through a clay treater 4 and then streamed 430 to a xylene re-run unit 5 to split C₈₊ hydrocarbons into a C₈ hydrocarbon stream 431 and C₉₊ (heavy aromatic MoGas) hydrocarbon stream (aromatic bottoms) 60. The xylene-re-run unit 5 is a distillation column including trays and/or structured packing and/or random packing to fractionate mixed xylenes from heavier aromatics. The C₈ hydrocarbon stream 431 proceeds to a para-xylene extraction unit 6 to recover para-xylene in a para-xylene product stream 433. The para-xylene extraction unit 6 also produces a C₇ cut MoGas stream 432, which combines with the C₇ cut MoGas stream 411 from the earlier splitter 3 to produce a combined C₇ cut MoGas stream 412. Other xylenes are recovered from the para-xylene extraction unit 6 and sent to xylene isomerization unit 7 by stream 434 to convert them to para-xylene. The isomerization unit 7 includes a catalyst, such as a zeolite, that assists in transforming ortho- and meta-xylenes to para-xylene. The isomerized xylenes are sent to a further splitter column 8 by stream 450. The converted fraction is recycled back to para-xylene extraction unit 6 from splitter column 8 by way of streams 452 (C₈₊) and 431 (C₈) and further re-passage through the xylene re-run unit 5. A top stream of lighter compounds 451 from the further splitter column 8 is recycled back to reformate splitter 1 for possible further benzene extraction. The heavy fraction from the xylene rerun unit 5 is recovered as aromatic bottoms (shown as C₉₊ and Hvy Aro MoGas in FIG. 2 at stream 60).

Turning to FIG. 3, a schematic of the prior introduction of a hydrodearylation unit is shown. Following from FIG. 1, a portion of the C₉₊ heavy aromatic bottoms 60 feeds from the ARC 400 into the hydrodearylation unit 600, while the other portion streams 50 into an atmospheric distillation unit ADU 500 first to obtain a stream of gasoline and C₉ and C₁₀ with the remaining C₁₁₊ compounds or a 180+° C. fraction feeding into the hydrodearylation unit 600 via a stream 61. Following hydrodearylation, the hydrodearylated bottoms are removed 70 as well as retrieved gas 62.

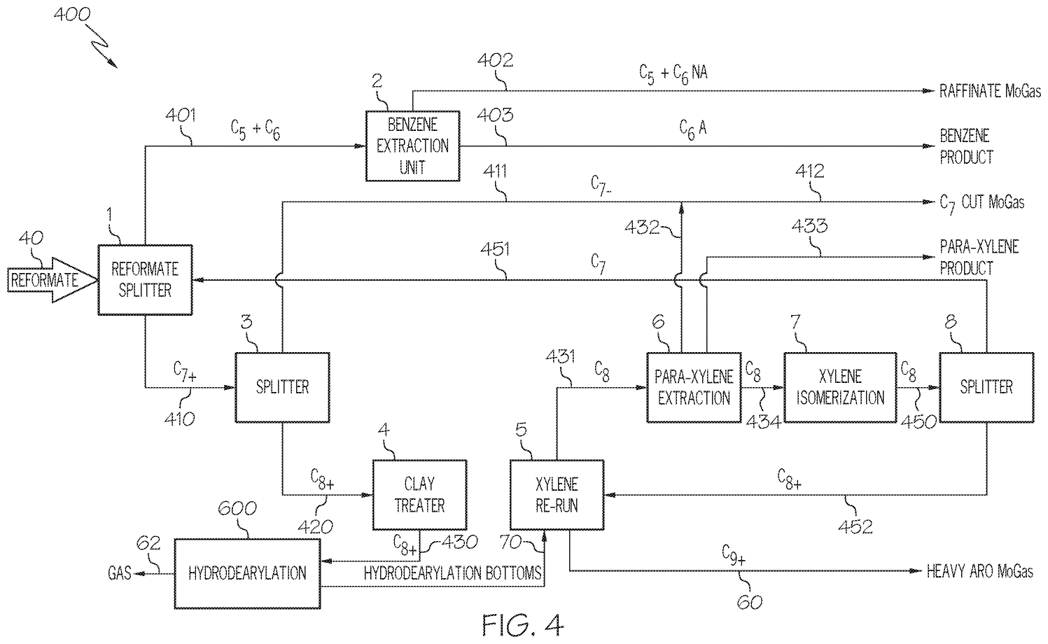

Turing to FIG. 4, a schematic of the present disclosure is depicted. Instead of feeding heavy aromatic bottoms of C₉₊ into a hydrodearylation unit 600, a C₈₊ stream 430 from a clay treater 4 feeds to a hydrodearylation unit 600. From the hydrodearylation unit 600, following flow over the catalyst with a hydrogen gas stream, a vented gas stream 62 and a stream of treated C₈₊ compounds 70 feeds back to the xylene re-run 5 and processed as described with FIG. 1.

According to an aspect, either alone or in combination with any other aspect, a process for the recovery of alkyl mono-aromatic compounds, the process including: (a) directing a feed stream from a clay treater of an aromatic recovery complex to a hydrodearylation unit, wherein the stream comprises C₈₊ compounds of one or more heavy alkyl aromatic compounds and alkyl-bridged multi-aromatic compounds; (b) hydrodearylating alkyl-bridged multi-aromatic compounds in the hydrodearylation unit by adding a hydrogen stream to the feed stream over a catalyst to produce an alkyl mono-aromatic compound containing stream; and (c) directing the alkyl mono-aromatic compound containing stream from (b) to a xylene re-run unit.

According to a second aspect, either alone or in combination with any other aspect, the alkyl-bridged alkyl multi-aromatic compounds in the feed stream include at least two benzene rings connected by an alkyl bridge group of at least two carbons, wherein the benzene rings are connected to different carbons of the alkyl bridge group,

According to a third aspect, either alone or in combination with any other aspect, the clay treater is operated at a temperature between 160° C. and 220° C.

According to a fourth aspect, either alone or in combination with any other aspect, the clay treater is operated at 1-20 bars pressure.

According to a fifth aspect, either alone or in combination with any other aspect, the clay treater is operated at a liquid hourly space velocity (LHSV) of about 0.5 hr⁻¹ to about 10 hr⁻¹.

According to a sixth aspect, either alone or in combination with any other aspect, the clay treater outlet effluent is substantially olefin free.

According to a seventh aspect, either alone or in combination with any other aspect, the clay treater outlet effluent has a bromine index less than 200.

According to an eighth aspect, either alone or in combination with any other aspect, the hydrogen stream is combined with the feed stream before being supplied to the hydrodearylation unit.

According to a ninth aspect, either alone or in combination with any other aspect, the hydrogen stream is comprised of a recycled hydrogen stream and a makeup hydrogen stream.

According to a tenth aspect, either alone or in combination with any other aspect, the hydrogen partial pressure is at least 15 bars

According to an eleventh aspect, either alone or in combination with any other aspect, the catalyst is presented as a catalyst bed in the hydrodearylation unit.

According to a twelfth aspect, either alone or in combination with any other aspect, a portion of the hydrogen stream is fed to the catalyst bed in the hydrodearylation unit to quench the catalyst bed.

According to a thirteenth aspect, either alone or in combination with any other aspect, the catalyst includes a support being at least one member selected from silica, alumina, titania or combinations thereof, and an acidic component selected from the group consisting of amorphous silica-alumina, zeolite, or combinations thereof.

According to a fourteenth aspect, either alone or in combination with any other aspect, the catalyst includes an IUPAC Group 8-10 metal selected from iron, cobalt, and nickel, or combinations thereof and an IUPAC Group 6 metal selected from the group consisting of molybdenum, tungsten, or combinations thereof.

According to a fifteenth aspect, either alone or in combination with any other aspect, the IUPAC 8-10 metal is 2 to 20 percent by weight of the catalyst and the IUPAC Group 6 metal is 1 to 25 percent by weight of the catalyst.

According to a sixteenth aspect, either alone or in combination with any other aspect, the catalyst is of a nickel, molybdenum, ultrastable Y-type zeolite, and γ-alumina support.

According to a seventeenth aspect, either alone or in combination with any other aspect, the hydrodearylation unit has an operating temperature of about 200 to about 450° C.

According to an eighteenth aspect, either alone or in combination with any other aspect, the hydrodearylation unit has a hydrogen partial pressure of about 5 to about 50 bars

According to a nineteenth aspect, either alone or in combination with any other aspect, the hydrodearylation unit has a feed rate of the hydrogen stream of about 100 to about 1000 standard liters per liter of feedstock.

According to a twentieth aspect, either alone or in combination with any other aspect, the aromatic recovery complex receives a reformate stream from a catalytic reforming unit.

According to a twenty-first aspect, either alone or in combination with any other aspect, a reformate splitter within the aromatic recovery complex splits the reformate stream into a C₅+C₆ stream that goes to a benzene extraction unit and a C₇₊ stream that feeds to a splitter.

According to a twenty-second aspect, either alone or in combination with any other aspect, the splitter divides the C₇₊ stream to a C₇ stream and a C₈₊ stream that passes through the clay treater and thereafter into the hydrodearylation unit.

According to a twenty-third aspect, either alone or in combination with any other aspect, the xylene re-run splits the alkyl mono-aromatic compound stream to a C₉₊ stream and a C₈ stream that flows to a para-xylene extraction unit and a xylene isomerization unit that recycles back to the xylene re-run unit.

### EXAMPLES

One or more of the previously described features will be further illustrated in the following example simulations.

### Example 1

Properties and composition of the C₈₊ stream at the outlet of the clay treater tower are shown in Table 1.

TABLE 1
Feedstock/Product properties and composition

| Property/Composition | Units | Feedstock | Product |
|---|---|---|---|
| Density | g/cc | 0.743 | 0.740 |
| Paraffins | | 0.57 | 0.57 |
| C7-MonoAromatics | wt. % | 0.22 | 0.22 |
| C8-MonoAromatics | wt. % | 52.59 | 54.59 |
| C9-MonoAromatics | wt. % | 23.68 | 23.68 |
| C10-MonoAromatics | wt. % | 20.08 | 20.08 |
| C11+ | wt. % | 2.86 | 0.86 |
| Total | wt. % | 100.00 | 100.00 |

The C₈₊ stream was contacted with a catalyst subjected to hydrodearylation conditions as follows: Pressure: 15-30 bars, temperature: 280-350° C., liquid hourly space velocity (“LHSV”) 1.7 hr⁻¹ (Equivalent LHSV based on di-aromatics in the stream: 140 hr⁻¹).

The problematic di-aromatics in the hydrodearylated product after being subjected to hydrodearylation (at 350° C. and 15 bar) dropped by 70%. The absolute wt. % difference in di-aromatic content between the feed to the hydrodearylation reactor and the hydrodearylated products is almost entirely at the benefit of mono-aromatic formation. The increased % of high-value mono-aromatics can then be processed upstream for benzene and para-xylene formation as shown in Table 1.

Throughout this disclosure, ranges are provided. It is envisioned that each discrete value encompassed by the ranges are also included. Additionally, the ranges which may be formed by each discrete value encompassed by the explicitly disclosed ranges are equally envisioned.

1. A process for the recovery of alkyl mono-aromatic compounds, the process comprising
(a) directing a C₈₊ feed stream from a clay treater of an aromatic recovery complex into a hydrodearylation unit, wherein the stream comprises C₈₊ compounds of one or more heavy alkyl aromatic compounds and alkyl-bridged multi-aromatic compounds;
(b) hydrodearylating alkyl-bridged multi-aromatic compounds in the hydrodearylation unit by adding a hydrogen stream to the C₈₊ feed stream over a catalyst to produce an alkyl mono-aromatic compound containing stream; and
(c) directing the alkyl mono-aromatic compound containing stream produced from (b) into a xylene re-run unit to split the alkyl mono-aromatic compound containing stream into a stream comprising C₈ and another stream comprising C₉.

2. The process of claim 1, wherein the at least one or more heavy alkyl aromatic compounds and alkyl-bridged alkyl multi-aromatic compounds in the feed stream comprise at least two benzene rings connected by an alkyl bridge group of at least two carbons, wherein the benzene rings are connected to different carbons of the alkyl bridge group.

3. The process of claim 1, wherein the clay treater is operated at a temperature between 160° C. and 220° C.

4. The process of claim 3, wherein the clay treater is operated at 1-20 bars pressure.

5. The process of claim 3, wherein the clay treater is operated at an liquid hourly space velocity (LHSV) of about 0.5 hr⁻¹ to about 10 hr⁻¹.

6. The process of claim 3, wherein the clay treater outlet effluent is substantially olefin free.

7. The process of claim 6, wherein the clay treater outlet effluent has a bromine index less than 200.

8. The process of claim 1, wherein the hydrogen stream is combined with the feed stream before being supplied to the hydrodearylation unit.

9. The process of claim 1, wherein the hydrogen stream is comprised of a recycled hydrogen stream and a makeup hydrogen stream.

10. The process of claim 1, wherein the hydrogen partial pressure is at least 15 bars.

11. The process of claim 1, wherein the catalyst is presented as a catalyst bed in the hydrodearylation unit.

12. The process of claim 11, wherein a portion of the hydrogen stream is fed to the catalyst bed in the hydrodearylation unit to quench the catalyst bed.

13. The process of claim 1, wherein the catalyst comprises a support being at least one member selected from the group consisting of silica, alumina, titania or combinations thereof, and an acidic component selected from the group consisting of amorphous silica-alumina, zeolite, or combinations thereof.

14. The process of claim 13, wherein the catalyst further comprises an IUPAC Group 8-10 metal selected from the group consisting of iron, cobalt, and nickel, or combinations thereof and an IUPAC Group 6 metal selected from the group consisting of molybdenum, tungsten, or combinations thereof.

15. The process of claim 14, wherein the IUPAC 8-10 metal is 2 to 20 percent by weight of the catalyst and the IUPAC Group 6 metal is 1 to 25 percent by weight of the catalyst.

16. The process of claim 1, wherein the catalyst comprises nickel, molybdenum, ultrastable Y-type zeolite, and γ-alumina support.

17. The process of claim 1, wherein step (b) includes an operating temperature within the hydrodearylation unit of about 200 to about 450° C.

18. The process of claim 1, wherein step (b) includes a hydrogen partial pressure within the hydrodearylation unit of about 5 to about 50 bars.

19. The process of claim 1, wherein step (b) includes a feed rate of the hydrogen stream to the hydrodearylation unit of about 100 to about 1000 standard liters per liter of feedstock.

20. The process of claim 1, wherein the aromatic recovery complex receives a reformate stream from a catalytic reforming unit.

21. The process of claim 20, wherein a reformate splitter within the aromatic recovery complex splits the reformate stream into a C₅+C₆ stream that goes to a benzene extraction unit and a C₇₊ stream that feeds to a splitter.

22. The process of claim 21, wherein the splitter divides the C₇₊ stream to a C₇ stream and a C₈₊ stream that passes through the clay treater and thereafter into the hydrodearylation unit.

23. The process of claim 1, wherein the C₈ stream from the xylene re-run unit flows to a para-xylene extraction unit and a xylene isomerization unit that recycles back to the xylene re-run unit.
